(19) United States
(12) Patent Application Publication
(10) Pub. No.: US 2014/0379611 A1
(43) Pub. Date: Dec. 25, 2014

(54) RETIREMENT PLANNING SYSTEM

(71) Applicant: Xerox Business Services, LLC, Dallas, TX (US)

(72) Inventor: Theodore Allen Goldman, Potomac, MD (US)

(21) Appl. No.: 13/922,786

(22) Filed: Jun. 20, 2013

(51) Int. Cl. G06Q 40/06

(52) U.S. Cl. CPC G06Q 40/06
USPC 705/36 R

(57) ABSTRACT

A retirement planning system uses employee age and salary information from an employer's employee information system, along with other information such as funds from other sources, to determine a target retirement account value for the employee, along with a periodic contribution amount that is expected to yield the target retirement account value upon retirement. The system may allocate an additional amount to serve as a shock absorber fund. The system may automatically enroll the employee in a retirement plan using the determined contribution level, and it may monitor the plan's value and make automatic adjustments to the contribution amounts to keep the employee on track toward retirement goals. When the employee reaches retirement, the system may manage distributions to the then-former employee. If the account value dips below an expected amount at any time, it may use the shock absorber funds to help maintain an account balance.

### BACKGROUND

The process of retirement planning is a challenge for even the most financially-aware individuals. Although various websites and software programs exist to help individuals plan for retirement, these sites typically leave the individual on his or her own when it comes to planning. Unless they work with a financial planner who manually manages the process, individuals are largely left to determine how much to save for retirement and how to spend their savings during retirement. There is a wealth of retirement education available, but it is not helping the majority of individuals who are retired or saving for retirement.

This document describes methods and systems that are directed to solving some or all of the problems described above, and/or other problems.

### BRIEF DESCRIPTION OF THE DRAWINGS

FIG. 1 is a block diagram of various elements of a system that may implement some or all of the processes described in this document.

FIG. 2 is a flowchart illustrating various elements of certain embodiments of a retirement planning process.

FIG. 3 is a flowchart illustrating various elements of certain embodiments of a retirement fund management and distribution process.

FIG. 4 is a chart illustrating the target outcomes of a retirement savings portfolio over time.

FIG. 5 illustrates an example of a first portion of a saver's user interface.

FIG. 6 illustrates an example of a second portion of a saver's user interface.

FIG. 7 is a block diagram of internal computer hardware that may be used to contain or implement program instructions according to an embodiment.

### SUMMARY

In an embodiment, a retirement income management system includes a retirement planning system comprising one or more processors, at least one computer-readable memory, and programming instructions. The planning system is in electronic communication with an employer's employee information system. When executing the programming instructions, the retirement planning may receive an employee's age and current salary information from the employee information system; determine a retirement age and payout period for the employee; use the employee's age, current salary information, retirement age and payout period to determine a target retirement account value for a retirement account of the employee at the employee's retirement age; use the target retirement account value and the current salary information to determine a periodic contribution amount for the employee, wherein the periodic contribution amount is an amount that, if the employee makes periodic retirement account contributions that equal at least the periodic contribution amount through retirement age at a default growth rate for the retirement account, will result in the employee's retirement account reaching the target retirement account value at the employee's retirement age; and send the employer's employee information system (without a requirement for any intervening command or approval by the employee) an instruction to make contributions to a retirement account for the employee in the employer's retirement plan by automatic payroll deduction of the periodic contribution amount for the employee.

Optionally, the system also may receive, from the employee information system, a communication comprising revised salary information for the employee and a current retirement account value. If so, the system may use the revised salary information to determine a new periodic contribution amount, and it may send the employer's employee information system an instruction to revise the contributions to the employee's retirement account to equal the new periodic contribution amount.

Optionally, the system also may monitor a total value for the employee's retirement account; determine a present value of the target retirement account value; and determine a new periodic contribution amount that, if made by the employee through retirement age at a default growth rate, will result in the employee's retirement account reaching the target retirement account value at the employee's retirement age. If the new amount is a stated level higher than the current amount, then the system may send the employer's employee information system an instruction to revise the contributions to the employee's retirement account to equal the new periodic contribution amount.

Optionally, when determining a periodic contribution amount, the system may: identify a target-date retirement fund that is available in the employer's retirement plan and which has a target date that is within a threshold range of the employee's retirement age; identify an expected growth rate for the identified target-date retirement fund; and determine the default growth rate as a function of the expected growth rate. In addition, when determining a target retirement account value the system may use the payout period and current salary information to determine a total required retirement funds value; determine an expected payment from one or more fixed distribution sources for the employee, wherein the fixed distribution sources comprise one or more of the following: social security, a defined contribution plan, and a pension plan; and deduct the expected payment from the one or more fixed distribution sources from the total required retirement funds to determine the target retirement account value.

Optionally, when determining a target retirement account value, the system may use the payout period and current salary information to determine a total required retirement funds value; determine a present account value for a second, non-affiliated retirement account that is not affiliated with the employer's retirement plan; determine an expected growth rate for the non-affiliated retirement account; use the employee's age, the employee's retirement age, the expected growth rate and the present account value for the non-affiliated retirement account to determine an at-retirement age value for the non-affiliated retirement account; deduct the at-retirement age value from the total required retirement funds to determine the target retirement account value; periodically request that the employee update the present account value for the non-affiliated retirement account; and after receiving an update, determine whether the target retirement account value should be revised based on the updated present account value for the non-affiliated retirement account.

Optionally, when determining a periodic contribution amount the system may use the target retirement account value and the current salary information to determine a periodic investment amount for the employee, determine an employer supplemental contribution amount, and determine the periodic contribution amount by deducting the employer supplemental contribution amount from the periodic investment amount.

Optionally, the system also may manage the employee's post-retirement distributions by: monitoring a total value for the employee's retirement account; determining a periodic distribution value for the employee's retirement account; and determining a present expected value of the target retirement account value. If the total value is less than a threshold that is based on the present expected value, then the system may reduce the periodic distribution value to a value that is expected to maintain the employee's post-retirement distributions from the employee's retirement account for a period at least equal to the payout period.

Optionally, the system also may manage the employee's post-retirement distributions by monitoring a total value for the employee's retirement account and maintain a notional allocation for that value available funds and a shock absorber fund; determining a periodic distribution value for the employee's retirement account; and determining a present expected value of the target retirement account value. If the total value is less than the present expected value, notionally transferring an amount from the shock absorber fund to the available funds in the employee's retirement account.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

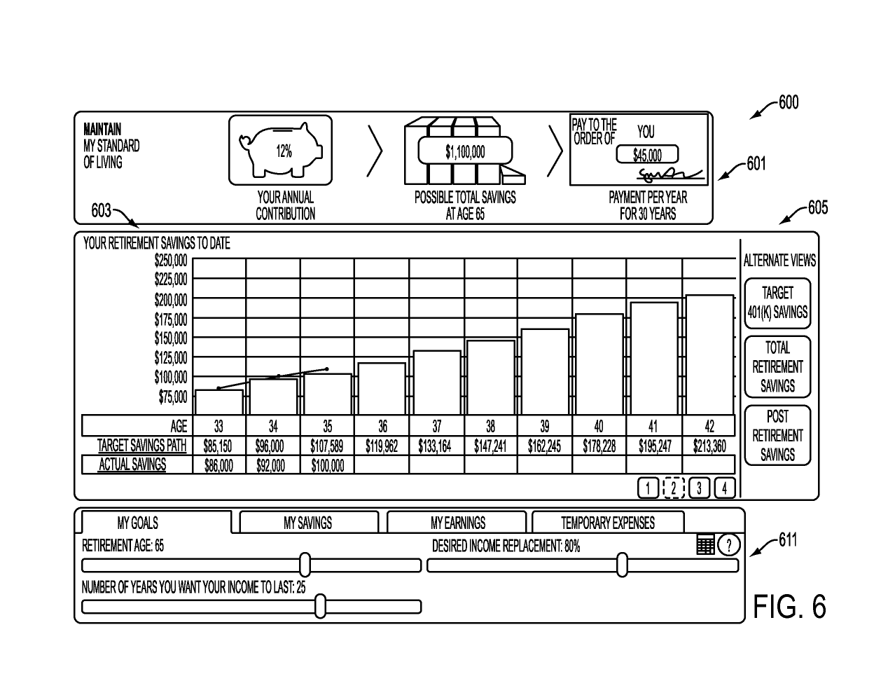

A “computing device” or a “processor” refers to a computer or other machine that performs one or more operations according to one or more programming instructions. Various elements of an example of a computing device or processor are described in reference to FIG. 6.

This document describes automated retirement planning methods and systems that are aimed at improving individuals' ability to save appropriately for retirement and manage their savings through retirement. The methods and systems may have particular value to employers who can offer access to the system as a benefit to their employees. As businesses have turned away from defined benefit plans and toward defined contribution plans as the primary retirement vehicle for their employees, it is becoming more and more important to help individuals learn how to develop and execute a secure retirement plan.

In various embodiments described below, a retirement planning system includes a computer-readable medium and one or more processors that implement an automated savings program for a group of individual savers. The system provides periodic monitoring functions and may provide both pre-retirement and post-retirement features. The system helps individuals better prepare for retirement, and it helps employers provide retirement benefits to their employees. The system may do this by automatically enrolling the individual in a retirement savings plan (such as a 401(k), 403(b), or Individual Retirement Account), automatically setting a reasonable retirement target, automatically determining a contribution process designed to deliver on the target, automatically causing the assets to be invested in one or more appropriate funds, automatically comparing actual results to target results and making appropriate adjustments based on the comparison, and automatically setting up a payout schedule for retirement to help the savings last.

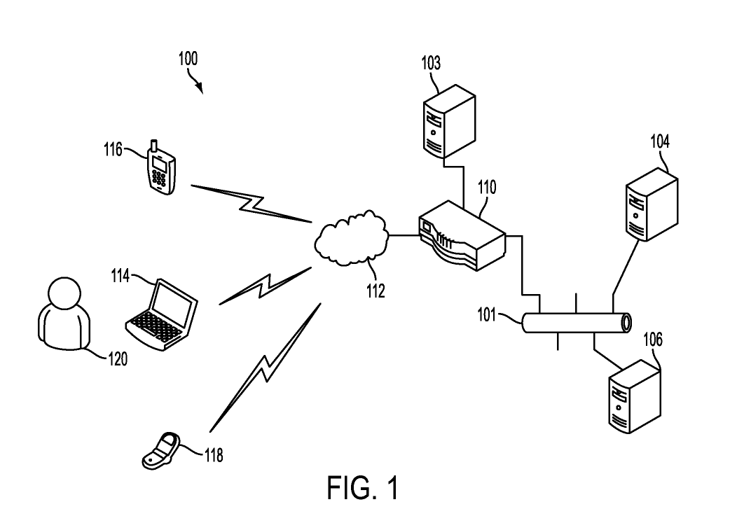

FIG. 1 illustrates an example of various hardware elements that may be used to implement a retirement planning system. Referring to FIG. 1, a system diagram is provided that describes a system 100 in which the methods described in this document can be implemented. System 100 includes or is connected to one or more networks 101, 112. As used in this document, the term “connected” refers to any configuration in which two or more devices may share data, programming instructions or other electronic communications with each other. Although FIG. 1 shows network 101 as a wired network and network 112 as a wireless network, any or all networks may be wired or wireless in various embodiments.

Connected to network 101 are any number of computing devices 103, 104, 106. Each computing device may be used by one or more individuals who are saving for retirement or using retirement savings, referred to in this document as “individuals,” “employees” if the system is offered in connection with an employer's retirement savings plan, or “savers.” Each computing device may be any suitable device, such as a desktop computer, laptop computer, ultrabook, mobile electronic device such as a tablet or smartphone, television, or other device capable of receiving data from a user interface and sending it to other devices, as well as receiving data from other devices and presenting it to a user. Each electronic device may be programmed with one or more software applications that implement some or all of the methods described in this document. Alternatively, any electronic device may be equipped with basic portal software, such as a browser, that implements software that is served to the device by a remote server.

Also connected to network 101 may be a networking device 110. Networking device 110 may be any device capable of forwarding, routing, or otherwise transmitting packets and/or messages through network 101. Connected to networking device 110 may be server 103. Server 103 may include various management and analytic software packages that enable a user or administrator of the network 101 to monitor and manage the print network. In addition, connected to the network may be one or more entity computing devices or systems, such as a computer system of an employer 104 who is an employer of one or more of the individuals, or the system of a financial service provider 106, such as a service provider who holds, invests and/or distributes retirement funds on behalf of the individuals.

Network device 110 is also capable of connecting to a communications network 112 such as the Internet. Note that in FIG. 1, network 112 and network 101 are shown as separate networks. Alternatively, network 112 and network 101 may be parts of the same network.

Any of the computing devices or a combination of the computing devices may implement a retirement income management system. For example, the financial planning system may be implemented by a financial services computing system 106 that is in electronic communication with an employer's employee information system 103.

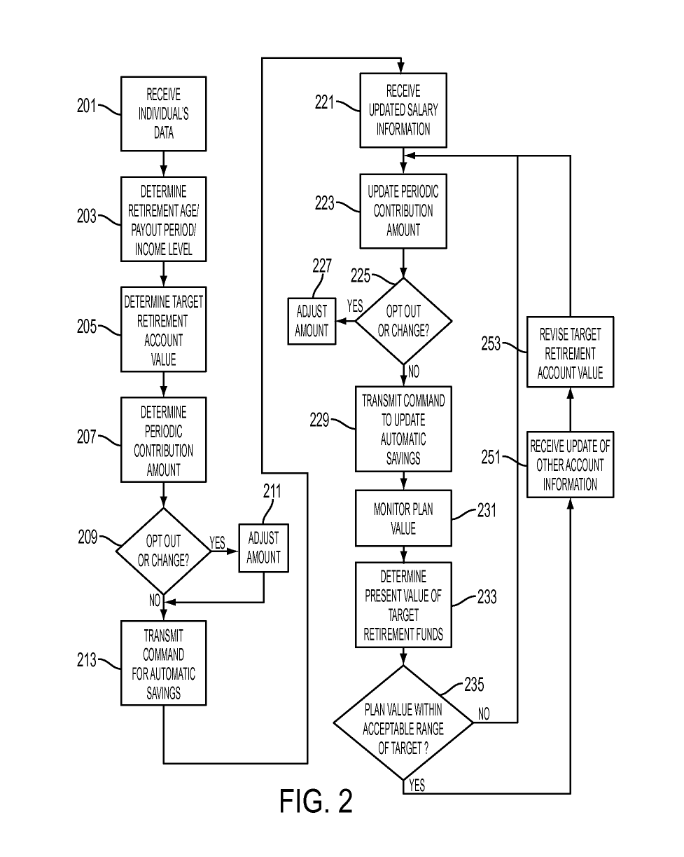

FIG. 2 is a flowchart describing various steps that a retirement planning system may implement. For example, to help manage a retirement plan for an individual who is an employee of an employer that provides the retirement plan as a benefit, the system may receive the individual's age and current salary information from the employee information system (step 201). This information may be input by the individual, received from the employer or received from another entity directly or via one or more intermediaries (such as a local database using previously received data) by any suitable means.

The system may determine a retirement age, payout period, and payout income level for the employee (step 203) using any suitable method. For example, the payout period may be based on actuarial data that indicates a life expectancy for the employee or the employee's spouse or other beneficiary, in which case the payout period may be the life expectancy minus the retirement age. The retirement age may be set by default, and/or the employee may be able to enter a retirement age or change to an age other than the default. The payout amount may be set by default, such as at 80% of the employee's pre-retirement salary, and/or the employee may be able to enter a payment amount or select an alternative amount, such as, an amount consistent with a basic sustenance level, or an amount needed to receive the full employer matching amount on his/her savings. This information may be input by the individual, received from an employer or received directly or via one or more intermediaries.

The system may use the employee's current age, current salary information, target retirement age, payout period, and retirement income level to determine a target retirement account value for the employee at the employee's expected retirement age (step 205). Optionally, the target retirement account value may include a “shock absorber fund” value, which is an amount that is above and beyond that which is determined to be required by a standard calculation. For example, when determining the target retirement account value the system may determine the actual required funds value plus 10% of that value as a shock absorber fund. Any suitable percentage or other amount may be used to notionally establish the amount of the shock absorber fund.

Optionally, when determining the target retirement account value, the system may use a current account value for the employee's retirement account, if a value is available to the system. If no such value is available, the system may use a default account value (such as zero). In addition, when determining the target retirement account value, if the employee may have other sources of income during retirement (such as another retirement account associated with a previous employer, or a fixed distribution source such as a pension plan, defined benefit plan, or Social Security payments), the system may use the calculation discussed above to first determine a total required retirement funds value. It may then determine an expected payment from the other source(s) of income and deduct the expected payment from the total required retirement funds value to yield the target retirement account value.

The system may use the target retirement account value and the current salary information to determine a periodic contribution amount for the employee (step 207). The periodic contribution amount is an amount that, if the employee makes periodic retirement account contributions that equal at least the periodic contribution amount through retirement age at a default growth rate for the retirement account, will result in the employee's retirement account reaching the target retirement account value at the employee's retirement age.

Optionally, if the employer provides any supplemental contribution amounts, such as funds to match the employee contributions to an employee's plan, or any non-match amounts such as a fixed percentage of salary contribution, then after determining the periodic contribution amount the system may first determine an overall periodic investment amount in step 207, and then deduct the employer supplemental contribution amount (i.e., match and non-match amounts) from the periodic investment amount to yield the periodic contribution amount.

The default growth rate used in step 207 (and certain other situations discussed below) may be a set point in the system, or the system may receive it from the employee or the employer, or the system may determine it by another suitable means. For example, to determine the default growth rate the system may identify or receive an identification of a target-date retirement fund that is available in the employer's retirement plan and which has a target date that is within a threshold range of the employee's anticipated retirement age. The system may receive, from the employer, from the retirement plan services provider, or from another source an expected growth rate from the identified target-date retirement fund. The system may then use the expected growth rate for the target-date retirement fund to determine the default growth rate. For example, the default growth rate may be set to equal the expected growth rate, or the system may use the expected growth rate in an equation with other factors to determine the default growth rate.

The following example illustrates how the process described above may implement various calculations. This example is for an employee age 35, with a salary of $50,000 per year, a target retirement age of 65, a target payout period of 25 years, and a target payout amount equal to 80% of pre-retirement salary. Furthermore, the following assumptions are used: default growth rate of 5%: future salary increase rate of 3%; projected Social Security amount assuming current rules remain intact; a $26,000 initial savings account value (from his current employer and former employers and IRAs); a $1,500 per year defined benefit pension payable at age 65; and a 10% cushion to establish a “shock absorber fund” to help mitigate post-retirement date adversities. The example also assumes the employer matches the employee's contributions at 100% up to the first 6% of pay deferred. These parameters are summarized in Table 1 below:

TABLE 1

| Process | Outcome | Source |
|---|---|---|
| Final Salary at Age 65 | $121,100 | Projected pay |
| Target Replacement Ratio | 80% | Set by employer |
| Annual Income Target | $96,880 | Calculation |
| Projected SS Benefit at 65 | $37,00 | Estimated with input from |
| | | employer |
| Other defined benefit sources | $1,500 | Frozen DB accrued benefit |
| NET ANNUAL INCOME | $58,380 | Calculation |
| TARGET | | |

The system may process these parameters to yield the target outcomes shown in Table 2:

TABLE 2

| Process | Outcome | Source |
|---|---|---|
| Net Annual Income Target at | $58,380 | Calculation |
| Age 65 | | |
| Pay Period from 65 to 90 | 25 years | Set by employer |
| Discount Rate | 5% | Set by employer (tied to |
| | | default investment fund) |
| Present Value at 65 | $864,000 | Calculation |
| Target Shock Absorber Fund | 10% | Set by employer |
| Cushion Amount | $86,400 | Calculation |
| TOTAL SAVINGS TARGET | $950,400 | Calculation |

Table 3 shows how various contributions to the employee's account may vary over time, and how the account may grow from the start at age 35 through the target retirement age of 65:

TABLE 3

| | | | | | Total |
|---|---|---|---|---|---|
| | | | Employee | Company | Account |
| Age | Pay | Savings % | Contribution | Match | Value |
| 35 | 50,000 | 12% | 0 | 0 | 26,000 |
| 36 | 51,500 | 12% | 6,000 | 3,000 | 36,436 |
| 37 | 53,000 | 12% | 6,180 | 3,090 | 47,668 |
| 38 | 54,600 | 12% | 6,360 | 3,180 | 59,736 |
| 39 | 56,200 | 12% | 6,552 | 3,276 | 72,700 |
| 40 | 57,900 | 12% | 6,744 | 3,372 | 86,604 |
| . | . | . | . | . | . |
| . | . | . | . | . | . |
| . | . | . | . | . | . |
| 65 | 121,100 | 12$ | 14,112 | 7,056 | 976,808 |

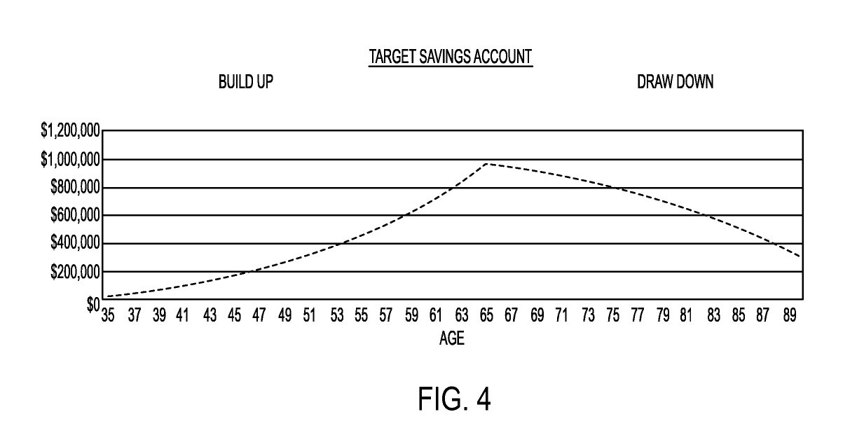

FIG. 4 is a chart illustrating the target outcomes over time for the example retirement savings portfolio described above. The outcomes show a target portfolio account value over time, build-up of retirement savings portfolio until the target retirement age of 65, and draw down during the employee's expected payout period.

Returning to FIG. 2, as noted above when determining the target retirement account value (step 205), the system may add an amount, as directed by the employer or employee, which this document may refer to as a “shock absorber fund”, to help mitigate unfavorable investment experience, outliving, the target payout period, or helping address other unforeseen expenses during retirement. This amount, if not needed, may also result in an additional inheritance to be left to heirs. This amount is included in the target account value and thus considered when determining the periodic contribution amount. It may be included in the employee's actual retirement account and notionally considered to be a separate fund (or a portion of the main account), or it may be invested in a separate account.

The system may transmit, to the employer's employee information system and/or a financial institution account management system optionally without the requirement for any intervening command or approval by the employee, an instruction to make contributions to a retirement account for the employee in the employer's retirement plan by automatic payroll deduction of the periodic contribution amount for the employee (step 213). If this is a new employee or an employee who is not yet enrolled in the employer's retirement plan, the system may also transmit an instruction to enroll the employee in a retirement plan. Optionally, the system may provide the employee an ability to opt out of or change the amount of any or all contributions (step 209). If the system receives a request from the employee to opt out of or change any contribution amount, the system may adjust or eliminate the contribution amount in accordance with the employee's instruction (step 211).

The system may automatically monitor the employee's retirement account value and make adjustments based on various changed circumstances. For example, if the employee's salary information increases or decreases, this fact may prompt the system to make a corresponding increase or decrease to the employee's contribution. If the system receives information indicating that the employee's salary changed (step 221), it may perform the contribution amount calculation again with the new salary information to determine a new periodic contribution amount (step 223). In some embodiments, the system may receive this information directly by a communication from the employer. In other embodiments, the employee may provide this information. The system may transmit, to the employer's employee information system, optionally without the requirement for any intervening command or approval by the employee, an instruction to make future contributions to the employee's retirement account in the new periodic contribution amount for the employee (step 229). Optionally, the system may provide the employee an ability to opt out of or change the amount of the new periodic contribution amount (step 225). If the system receives a request from the employee to opt out of or change the new contribution amount, the system may adjust or eliminate the contribution amount in accordance with the employee's instruction (step 227).

If the updated periodic contribution amount increases by at least a full percentage of the employee's salary, then a new periodic contribution amount will be implemented, subject to the employee making another decision to override this calculation. If the updated periodic contribution amount is lower than the current amount (i.e. due to favorably investment experience), then no adjustment downward will be made and the current periodic contribution amount will continue until the next update. These periodic reviews will happen at least annually, but could be implemented at the discretion of the employer due to special circumstances, such as extreme investment periods or changes to the defined contribution plan as implemented by the employer. Optionally, the monitored total retirement account value may include additional accounts for the employee, including accounts not necessarily part of the employer's retirement plan. The system may receive the additional account information from the employee, or by data collection if authorized by the employee.

As another example of how the system may monitor circumstances and make adjustments, the system may monitor the employee's current total retirement account value (step 231), determine a present value of the employee's target retirement account value (step 233), and determine whether the current total retirement account value is still on track to meet the target payment amount (step 235). For example, the account may be deemed “on track” if the new calculation results in a deferral that is equal to or less than the current deferral. If the monitored total retirement account value is not within the accepted range of the present value, the system may run the contribution amount calculation again to determine a new periodic contribution amount that, if made by the employee through retirement age at a default growth rate, will result in the employee's retirement account reaching the target retirement account value at the employee's retirement age (step 223). This determination may be done using calculations such as those shown in Table 2 above, using the current total account value. The default growth rate may be a set point in the system, or it may be received from the employee or the employer. The system may transmit, to the employer's employee information system, optionally without the requirement for any intervening command or approval by the employee, an instruction to make contributions to the employee's retirement account in the new periodic contribution amount for the employee (step 229). Optionally, the system may provide the employee an ability to opt out of or change the amount of the new periodic contribution amount (step 225). If the system receives a request from the employee to opt out of or change the new contribution amount, the system may adjust or eliminate the contribution amount in accordance with the employee's instruction (step 227).

As noted above, before determining the target retirement account value the system may first determine a total required retirement funds value and then deduct other sources of income to yield the target retirement account. Other sources of retirement income that the system may consider in the total required retirement funds value include the employee's retirement accounts that are not affiliated with the employer's retirement plan. If so, the system may receive, from the employee in connection with receiving the employee's data (step 201), a present account value for each additional retirement account. The system also may determine an expected growth rate for the account using historic account data, default account data, or any suitable means. The system may use the employee's current age, target retirement age, expected growth rate for the additional account and present account value for the additional account to determine an at-retirement age value for the additional account. If all of this information is not available, the system may use the information available along with default or estimated values for the unavailable information to determine the at-retirement age value for the additional account. The system may periodically ask the employee to update the present account value for the second (non-affiliated) account. Then, after receiving an update (step 251), the system may determine whether the non-affiliated account's value has substantially increased or decreased in comparison to the employer retirement account value, and if so it may determine that a corresponding decrease or increase to the target retirement account value is needed (step 253), and it may generate a recommendation or instruction to do the same.

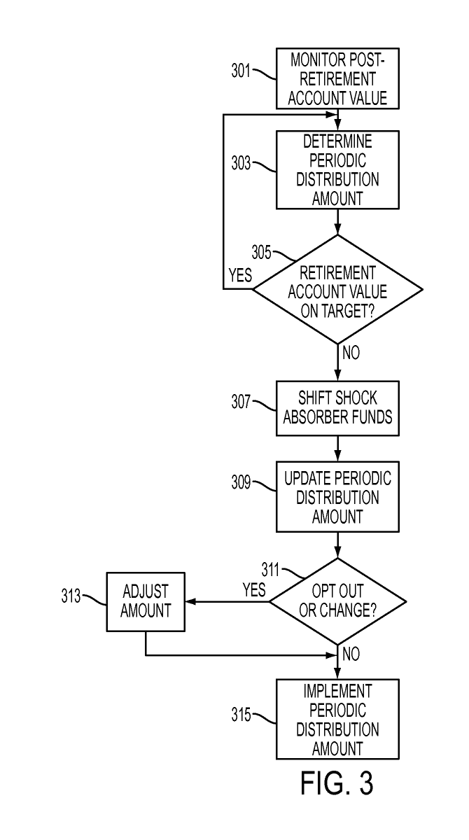

FIG. 3 illustrates various steps that the system may implement to distribute funds to the employee after the employee reaches retirement. For example, the system may manage the employee's post-retirement distributions by monitoring a total available value for the employee's retirement account (step 301), determining a periodic distribution value for the employee's retirement account, and determining a present expected value of the target retirement account value (step 303). The total value may be notionally separated into an available value and a supplemental or side fund amount, referred to in this document as a shock absorber fund amount. If the total available value of the account is less than a threshold that is based on the present expected value, this may indicate that the employee's retirement funds are dwindling too quickly (step 305). The threshold may be the present expected value itself, or some function of the present expected value, such as 90% of the present expected value (which indicates that the actual value is 10% below the expected value). Other thresholds are possible.

If so, the system may determine an amount to be notionally transferred from the shock absorber fund into the available funds such that the monthly payment can continue to match the target payout (step 307). If the shock absorber fund does not have enough to allow the payment to reach the target payout (or is fully depleted), or if a shock absorber fund is not set, then the system may determine a new periodic distribution amount that will maintain the funds through the remainder of the employee's payout period will be determined and paid to the retiree (step 309). If the employee opts out or wants to change the new amount (step 311), the system may honor the employee's request. The funds are fully accessible to the retiree at any time. If withdrawals are made over and above what is paid to the retiree as a monthly check then the shock absorber fund will be utilized to offset the withdrawal. Otherwise, it may generate an instruction to automatically reduce the periodic distribution value to the value that is expected to maintain the employee's post-retirement distributions from the employee's retirement account for a period at least equal to the payout period (step 315).

If fund performance exceeds the target performance and the account value is greater than targeted, then the shock absorber fund may increase by such amount and the target payment streams will continue to the retiree. The following example illustrates how payments may be adjusted based on actual experience:

As with the savings management process, the system may give the employee an option to change or opt out of any change to a periodic distribution value before implementing the change (step 309). If the employee opts out of or changes the new post-retirement distribution value, then the system may adjust the post-retirement distribution values to meet the employee's request (step 313).

An example of how the system may calculate various levels follows. For example, when determining a Target Retirement Account value, the system may use a formula such as:

TRA=(TRP×STRA×aₓi−Social Security−Defined Benefit Annuity)×(1+SAFP)−Projected Account Balance at Target Retirement Age from Prior Employer Savings

Where: (i) PV=Present value; (ii) TRA=Target Retirement Account value; (iii) TRP=Target Replacement Percentage; (iv) TRPP=Target Retirement Payout Period; (v) STRA=Salary at Target Retirement Age; (vi) i=assumed investment return during retirement; (vii) aₓi=immediate annuity certain at target retirement age payable for the Target Retirement Payout Period (TRPP) based on the assumed investment return i during retirement; and (viii) SAFP=Shock Absorber Fund Percentage. In this calculation, STRA may be calculated as: STRA=current salary×(1+s)̂(Target Retirement Age−Current Age), where s is the assumed annual salary increase.

To determine a monthly retirement payout (MRP) amount, one may consider: MRP=Target Retirement Age Account Balance from Available Funds/aₓi, where: (i) i=assumed investment return during retirement; (ii) aₓi=immediate annuity certain at target retirement age payable for the Target Payout Period (TPP) based on the assumed investment return i during retirement; and; (iii) Target Retirement Age Account Balance from Available Funds=Total Retirement Age Account Balance−Total Shock Absorber Fund at Target Retirement Age.

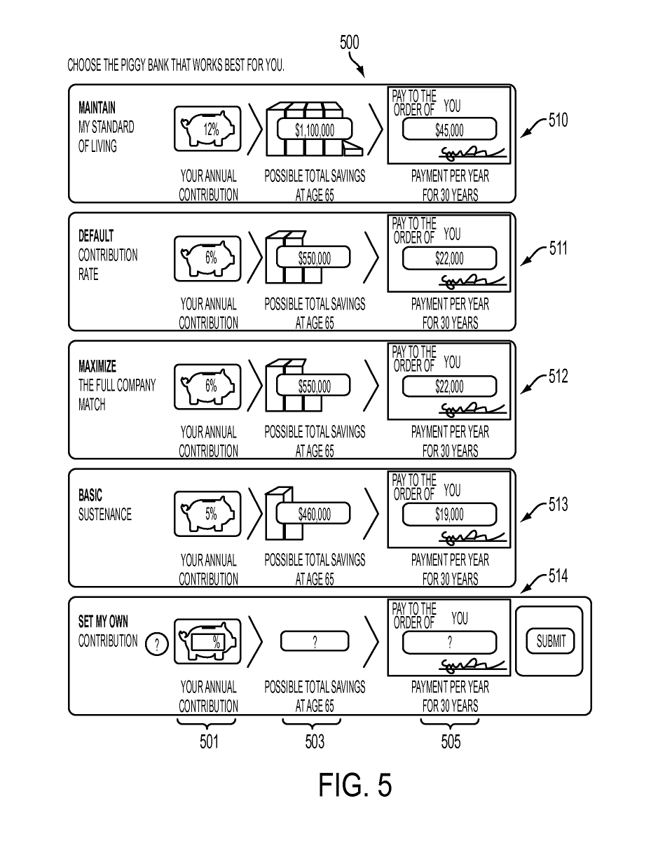

The system may provide its functions to the individual saver through one or more user interfaces that are presented to the individual saver on the individual's computing devices. FIG. 5 is an example of a portion (in this case a web page or mobile device screen) of an employee-saver's user interface 500. The user interface may output several savings scenarios 510-514 to the user, including options that show various user-selectable periodic contribution levels 501 needed for various target retirement account values 503. The interface also may show an expected payment value 505 (such as an annual distribution amount) during retirement for each scenario. When the user selects one of the scenarios, the system may automatically enroll the user in a retirement plan or adjust an existing retirement plan to match the selected scenario.

FIG. 6 illustrates an additional dashboard portion 600 of an employee-saver user interface that allows the employee to monitor and/or make changes to a retirement savings plan. The interface may include a visualization dashboard 603 that outputs actual and/or projected values of an employee's retirement plan based on current data and a selected scenario 601. The user may be able to adjust the values shown on the dashboard by selecting alternate views such as pre-retirement and post-retirement views. The interface also may include one or more parameter adjustment interfaces 611 through which the user may alter one or more parameters such as a target retirement age or payout period. The system will alter the data shown in the visualization dashboard 603 to match the new parameters selected by the user.

Similarly, the system may include an employer user interface through which an employee may, enroll, view data for, set parameters, and otherwise implement aspects of a retirement plan for its employees.

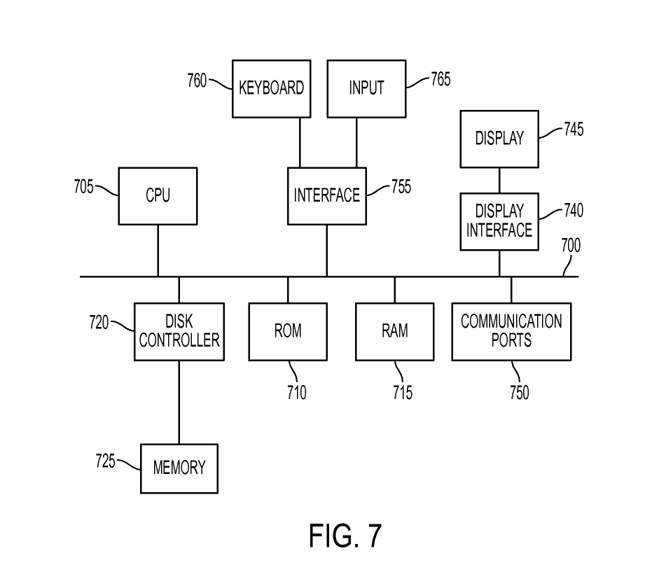

FIG. 7 depicts a block diagram of an example of internal hardware that may be used to contain or implement program instructions, such as the process steps discussed above in reference to FIGS. 2 and 3, according to embodiments. A bus 700 serves as an information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an example of a processing device, computing device or processor as such terms are used within this disclosure. Read only memory (ROM) 710 and random access memory (RAM) 715 constitute examples of memory devices or processor-readable storage media.

A controller 720 interfaces with one or more optional tangible, computer-readable memory devices 725 to the system bus 700. These memory devices 725 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 740 may permit information from the bus 700 to be displayed on the display 745 in audio, visual, graphic or alphanumeric format. Communication with external devices, such as a printing device, may occur using various communication ports 750. A communication port 750 may be attached to a communications network, such as the Internet or an intranet.

The hardware may also include an interface 755 which allows for receipt of data from input devices such as a keyboard 760 or other input device 765 such as a mouse, a joystick, a touch screen, a remote control, a pointing device, a video input device and/or an audio input device.

Some or all of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the claims.

1. A retirement income management system, comprising:
a retirement planning system, the planning system being in electronic communication with an employer's employee information system and comprising one or more processors, at least one computer-readable memory, and programming instructions that are configured to instruct one or more of the processors to:
receive an employee's age and current salary information from the employee information system;
determine a retirement age and payout period for the employee;
use the employee's age, current salary information, retirement age and payout period to determine a target retirement account value for a retirement account of the employee at the employee's retirement age;
use the target retirement account value and the current salary information to determine a periodic contribution amount for the employee, wherein the periodic contribution amount is an amount that, if the employee makes periodic retirement account contributions that equal at least the periodic contribution amount through retirement age at a default growth rate for the retirement account, will result in the employee's retirement account reaching the target retirement account value at the employee's retirement age; and
send, to the employer's employee information system without a requirement for any intervening command or approval by the employee, an instruction to make contributions to a retirement account for the employee in the employer's retirement plan by automatic payroll deduction of the periodic contribution amount for the employee.

2. The system of claim 1, further comprising additional programming instructions that are configured to instruct one or more of the processors to:
receive, from the employee information system, a communication comprising revised salary information for the employee and a current retirement account value:
use the revised salary information to determine a new periodic contribution amount; and
send, to the employer's employee information system, an instruction to revise the contributions to the employee's retirement account to equal the new periodic contribution amount.

3. The system of claim 1, further comprising additional programming instructions that are configured to instruct one or more of the processors to:
monitor a total value for the employee's retirement account;
determine a present value of the target retirement account value;
determine a new periodic contribution amount that, if made by the employee through retirement age at a default growth rate, will result in the employee's retirement account reaching the target retirement account value at the employee's retirement age; and
if the new amount is a stated level higher than the current amount, send, to the employer's employee information system, an instruction to revise the contributions to the employee's retirement account to equal the new periodic contribution amount.

4. The system of claim 1, wherein the instructions that are configured to instruct one or more of the processors to determine a periodic contribution amount comprise instructions to:
identify a target-date retirement fund that is available in the employer's retirement plan and which has a target date that is within a threshold range of the employee's retirement age;
identify an expected growth rate for the identified target-date retirement fund; and
determine the default growth rate as a function of the expected growth rate.

5. The system of claim 1, wherein the instructions that are configured to instruct one or more of the processors to determine a target retirement account value comprise instructions to:
use the payout period and current salary information to determine a total required retirement funds value;
determine an expected payment from one or more fixed distribution sources for the employee, wherein the fixed distribution sources comprise one or more of the following: social security, a defined contribution plan, and a pension plan; and
deduct the expected payment from the one or more fixed distribution sources from the total required retirement funds to determine the target retirement account value.

6. The system of claim 1, wherein the instructions that are configured to instruct one or more of the processors to determine a target retirement account value comprise instructions to:
use the payout period and current salary information to determine a total required retirement funds value;
determine a present account value for a non-affiliated retirement account that is not affiliated with the employer's retirement plan;
determine an expected growth rate for the non-affiliated retirement account;
use the employee's age, the employee's retirement age, the expected growth rate and the present account value for the non-affiliated retirement account to determine an at-retirement age value for the non-affiliated retirement account;
deduct the at-retirement age value from the total required retirement funds to determine the target retirement account value;
periodically request that the employee update the present account value for the non-affiliated retirement account; and
after receiving an update, determine whether the target retirement account value should be revised based on the updated present account value for the non-affiliated retirement account.

7. The system of claim 1, wherein:
the instructions that are configured to instruct one or more of the processors to determine a periodic contribution amount comprise instructions to:
use the target retirement account value and the current salary information to determine a periodic investment amount for the employee;
determine an employer supplemental contribution amount; and
determine the periodic contribution amount by deducting the employer supplemental contribution amount from the periodic investment amount.

8. The system of claim 1, further comprising additional programming instructions that are configured to instruct one or more of the processors to manage the employee's post-retirement distributions by:
monitor a total value for the employee's retirement account;
determine a periodic distribution value for the employee's retirement account;
determine a present expected value of the target retirement account value; and
if the total value is less than a threshold that is based on the present expected value, reduce the periodic distribution value to a value that is expected to maintain the employee's post-retirement distributions from the employee's retirement account for a period at least equal to the payout period.

9. The system of claim 1, further comprising additional programming instructions that are configured to instruct one or more of the processors to manage the employee's post-retirement distributions by:
monitoring a total value for the employee's retirement account and maintain a notional allocation for that value available funds and a shock absorber fund;
determining a periodic distribution value for the employee's retirement account;
determining a present expected value of the target retirement account value; and
if the total value is less than the present expected value, notionally transferring an amount from the shock absorber fund to the available funds in the employee's retirement account.

10. A retirement income management system, comprising:
a retirement planning system, the planning system being in electronic communication with an employer's employee information system and comprising one or more processors, at least one computer-readable memory, and programming instructions that are configured to instruct one or more of the processors to:
receive an employee's age and current salary information from the employee information system;
determine a retirement age and payout period for the employee;
use the employee's age, current salary information, retirement age and payout period to determine a target retirement account value for a retirement account of the employee at the employee's retirement age;
use the target retirement account value and the current salary information to determine a periodic contribution amount for the employee, wherein the periodic contribution amount is an amount that, if the employee makes periodic retirement account contributions that equal at least the periodic contribution amount through retirement age at a default growth rate for the retirement account, will result in the employee's retirement account reaching the target retirement account value at the employee's retirement age;
send, to the employer's employee information system without a requirement for any intervening command or approval by the employee, an instruction to make contributions to a retirement account for the employee in the employer's retirement plan by automatic payroll deduction of the periodic contribution amount for the employee;
receive, from the employee information system, a communication comprising revised salary information for the employee and a current retirement account value:
use the revised salary information to determine a new periodic contribution amount; and
send, to the employer's employee information system, an instruction to revise the contributions to the employee's retirement account to equal the new periodic contribution amount; and
additional programming instructions that are configured to instruct one or more of the processors to manage the employee's post-retirement distributions by:
monitoring a total value for the employee's retirement account;
determining a periodic distribution value for the employee's retirement account;
determining a present expected value of the target retirement account value; and
if the total value is less than a threshold that is based on the present expected value, reducing the periodic distribution value to a value that is expected to maintain the employee's post-retirement distributions from the employee's retirement account for a period at least equal to the payout period.

11. A method of managing retirement income, comprising:
by one or more processors of a retirement planning system, the planning system being in electronic communication with an employer's employee information system, executing programming instructions that cause one or more of the processors to:
receive an employee's age and current salary information from the employee information system;
determine a retirement age and payout period for the employee;
use the employee's age, current salary information, retirement age and payout period to determine a target retirement account value for a retirement account of the employee at the employee's retirement age;
use the target retirement account value and the current salary information to determine a periodic contribution amount for the employee, wherein the periodic contribution amount is an amount that, if the employee makes periodic retirement account contributions that equal at least the periodic contribution amount through retirement age at a default growth rate for the retirement account, will result in the employee's retirement account reaching the target retirement account value at the employee's retirement age; and
send, to the employer's employee information system without a requirement for any intervening command or approval by the employee, an instruction to make contributions to a retirement account for the employee in the employer's retirement plan by automatic payroll deduction of the periodic contribution amount for the employee.

12. The method of claim 11, further comprising executing additional programming instructions that cause one or more of the processors to:
receive, from the employee information system, a communication comprising revised salary information for the employee and a current retirement account value:
use the revised salary information to determine a new periodic contribution amount; and
send, to the employer's employee information system, an instruction to revise the contributions to the employee's retirement account to equal the new periodic contribution amount.

13. The method of claim 11, further comprising executing additional programming instructions that cause one or more of the processors to:
monitor a total value for the employee's retirement account;
determine a present value of the target retirement account value;
determine a new periodic contribution amount that, if made by the employee through retirement age at a default growth rate, will result in the employee's retirement account reaching the target retirement account value at the employee's retirement age; and
if the new amount is a stated level higher than the current amount, send, to the employer's employee information system, an instruction to revise the contributions to the employee's retirement account to equal the new periodic contribution amount.

14. The method of claim 14, wherein determining the periodic contribution amount comprises:
identifying a target-date retirement fund that is available in the employer's retirement plan and which has a target date that is within a threshold range of the employee's retirement age;
identifying an expected growth rate for the identified target-date retirement fund; and
determining the default growth rate as a function of the expected growth rate.

15. The method of claim 11, wherein determining the target retirement account value comprises:
using the payout period and current salary information to determine a total required retirement funds value;
determining an expected payment from one or more fixed distribution sources for the employee, wherein the fixed distribution sources comprise one or more of the following: social security, a defined contribution plan, and a pension plan; and
deducting the expected payment from the one or more fixed distribution sources from the total required retirement funds to determine the target retirement account value.

16. The system of claim 11, wherein determining a target retirement account value comprises:
using the payout period and current salary information to determine a total required retirement funds value;
determining a present account value for a non-affiliated retirement account that is not affiliated with the employer's retirement plan;
determining an expected growth rate for the non-affiliated retirement account;
using the employee's age, the employee's retirement age, the expected growth rate and the present account value for the non-affiliated retirement account to determine an at-retirement age value for the non-affiliated retirement account;
deducting the at-retirement age value from the total required retirement funds to determine the target retirement account value;
periodically requesting that the employee update the present account value for the non-affiliated retirement account; and
after receiving an update, determining whether the target retirement account value should be revised based in the updated present account value for the non-affiliated retirement account.

17. The method of claim 11, wherein:
determining the periodic contribution amount comprises:
using the target retirement account value and the current salary information to determine a periodic investment amount for the employee;
determining an employer supplemental contribution amount; and
determining the periodic contribution amount by deducting the employer supplemental contribution amount from the periodic investment amount.

18. The method of claim 11, further comprising executing additional programming instructions that cause one or more of the processors to manage the employee's post-retirement distributions by:
monitoring a total value for the employee's retirement account;
determining a periodic distribution value for the employee's retirement account;
determining a present expected value of the target retirement account value; and
if the total value is less than a threshold that is based on the present expected value, reducing the periodic distribution value to a value that is expected to maintain the employee's post-retirement distributions from the employee's retirement account for a period at least equal to the payout period.

19. The method of claim 11, further comprising executing additional programming instructions that cause one or more of the processors to manage the employee's post-retirement distributions by:
monitoring a total value for the employee's retirement account and maintain a notional allocation for that value available funds and a shock absorber fund;
determining a periodic distribution value for the employee's retirement account;
determining a present expected value of the target retirement account value; and
if the total value is less than the present expected value, notionally transferring an amount from the shock absorber fund to the available funds in the employee's retirement account.
